(19) United States
(12) Patent Application Publication
(10) Pub. No.: US 2025/0360046 A1
(43) Pub. Date: Nov. 27, 2025

(54) SEXUAL STIMULATION DEVICE

(71) Applicant: HYTTO PTE. LTD, Singapore (SG)

(72) Inventors: Dan LIU, Singapore (SG); Jilin QIU, Singapore (SG)

(73) Assignee: HYTTO PTE. LTD, Singapore (SG)

(21) Appl. No.: 19/296,486

(22) Filed: Aug. 11, 2025

Related U.S. Application Data
(63) Continuation-in-part of application No. 18/629,191, filed on Apr. 8, 2024, now Pat. No. 12,433,817.

(51) Int. Cl. A61H 19/00; A61H 9/00

(52) U.S. Cl. CPC A61H 19/32; A61H 9/0007; A61H 9/0092; A61H 19/34; A61H 2201/0103; A61H 2201/1409; A61H 2201/16; A61H 2201/5056

(57) ABSTRACT

Embodiments of the present invention disclose a sexual stimulation device. The sexual stimulation device includes an accommodating element, a valve assembly and an actuation member. The accommodating element is configured for allowing insertion of male genitalia therein. The valve assembly includes at least a valve, a first channel and a second channel. The actuation member is configured to operate the valve to fluidically couple an external ambience to an inside or a surrounding of the accommodating element through the valve assembly. The actuation member is configured to operate the valve in the first mode to allow a first fluid flow through the first channel between the inside or the surrounding of the accommodating element and the external ambience, and operate the valve in the second mode to allow a second fluid flow through the second channel between the inside or the surrounding of the accommodating element and the external ambience.

This application is a Continuation-in-Part of U.S. application Ser. No. 18/629,191, filed Apr. 8, 2024.

### TECHNICAL FIELD

The present invention relates generally to devices for sexual pleasure, and more particularly relates to sexual stimulation devices for providing sexual stimulation to users.

### BACKGROUND

Self-sexual intercourse (or masturbation) is a common activity among adults irrespective of gender, race, and so forth. Masturbation is generally referred to as the stimulation of genital organs to obtain sexual pleasure.

Sexual pleasure can be achieved by an individual or a group of individuals (irrespective of gender) by using sex toys. Conventional, sex toys are generally simple and can have a vibration feature for providing sexual pleasure. In conventional sex toys, a degree of sexual stimulation may be manually controlled. However, as these conventional sex toys are self-operated by the individual for experiencing sexual pleasure by using a single setting in the sex toy, the individual may not always feel the same level of stimulation at every instance using the conventional sex toy. Additionally, the arousal of the individual may change periodically based on mood and environment, thus the stimulation produced by the adult toy using the single vibration setting may not satisfy the individual. The vibration stimulation effect is related to the intensity of a vibrating motor equipped in the sex toy. However, installation of the vibrating motor in the sex toys is difficult. Further, when the vibrating motor is operating at high frequency there is a significant increase in the noise, thus resulting in an unpleasant experience. In addition, the sex toys may be configured to provide suction action for providing stimulation to the users. The suction action may be provided using a suction element equipped in the sex toys. In most cases, the suction element has limited functionality or may not be able to perform frequent or rapid suction actions (inflate and/or deflate) which results in an unsatisfactory experience for the user.

Therefore, there is a need for a sexual stimulation device to provide a satisfying masturbation experience to the individual, in addition to providing other technical advantages.

### SUMMARY

Various embodiments of the present disclosure disclose a sexual stimulation device for sexual pleasure.

In an embodiment, a sexual stimulation device is disclosed. The sexual stimulation device includes a housing and at least one linkage member. Further, each linkage member of the at least one linkage member includes a first end coupled to the housing and a second end disposed freely relative to the housing. The sexual stimulation device further includes at least one actuation member and one or more stimulation elements. The at least one actuation member and the one or more stimulation elements are disposed in the housing. The one or more stimulation elements are operatively coupled to the at least one linkage member. Further, the sexual stimulation device includes a control circuitry. The control circuitry is operatively coupled to at least the at least one actuation member, and the one or more stimulation elements. The control circuitry is configured to at least activate the one or more stimulation elements performs predefined actions corresponding to operating parameters appended in a control signal, thereby providing sexual stimulation to the user's body while the sexual stimulation device is in contact with the user's body.

In another embodiment, a sexual stimulation device is disclosed. The sexual stimulation device includes a housing, one or more stimulation elements, and at least one actuation member disposed in the housing. The at least one actuation member is fluidically coupled to the one or more stimulation elements through a valve assembly. The valve assembly includes at least a first channel and a second channel. The first channel is fluidically coupled to the one or more stimulation elements and the actuation member, and the second channel is fluidically coupled to the actuation member and the ambient atmosphere. Further, the sexual stimulation device includes a control circuitry operatively coupled to the at least one actuation member and the one or more stimulation elements. The control circuitry is configured to regulate the valve assembly for actuating the at least one actuation member to operate the one or more stimulation elements between an expanded state and a compressed state through the first channel and the second channel to provide sexual stimulation to the user's body while the sexual stimulation device is in contact with the user's body.

In another embodiment, a sexual stimulation device is disclosed. The sexual stimulation device includes an accommodating element, a valve assembly and an actuation member. The accommodating element is configured for allowing insertion of male genitalia therein. The valve assembly includes at least a valve, a first channel and a second channel. The actuation member is configured to operate the valve at least in a first mode and a second mode, so as to fluidically couple an external ambience to an inside or a surrounding of the accommodating element through the valve assembly. The actuation member is also configured to operate the valve in the first mode to allow a first fluid flow through the first channel between the inside or the surrounding of the accommodating element and the external ambience, and operate the valve in the second mode to allow a second fluid flow through the second channel between the inside or the surrounding of the accommodating element and the external ambience. The first fluid flow and the second fluid flow are separately controllable.

In another embodiment, a sexual stimulation device used to act on a user's orifice or surroundings thereof is disclosed. The sexual stimulation device includes a valve assembly and an actuation member. The valve assembly includes at least a valve, a first channel and a second channel. The actuation member is configured to operate the valve at least in a first mode and a second mode, so as to fluidically couple an external ambience to the orifice or the surroundings thereof through the valve assembly. The actuation member is also configured to operate the valve in the first mode to allow a first fluid flow through the first channel between the orifice or the surroundings thereof and the external ambience, and operate the valve in the second mode to allow a second fluid flow through the second channel between the orifice or the surroundings thereof a and the external ambience. The first fluid flow and the second fluid flow are separately controllable.

### BRIEF DESCRIPTION OF THE FIGURES

The following detailed description of illustrative embodiments is better understood when read in conjunction with the appended drawings. For the purposes of illustrating the present disclosure, exemplary constructions of the disclosure are shown in the drawings. However, the present disclosure is not limited to a specific device, or a tool and instrumentalities disclosed herein. Moreover, those in the art will understand that the drawings are not to scale. Wherever possible, like elements have been indicated by identical numbers:

FIG. 1 illustrates an exploded view of a sexual stimulation device, in accordance with an embodiment of the present disclosure;

FIG. 2A illustrates a sectional view of the sexual stimulation device depicting a housing including at least one linkage member and a first stimulation element, in accordance with an embodiment of the present disclosure;

FIG. 2B illustrates a perspective view of a linkage member of the at least one linkage member of FIG. 2A, in accordance with an embodiment of the present disclosure;

FIG. 3 illustrates a perspective of the sexual stimulation device depicting an accommodating element and the housing, in accordance with an embodiment of the present disclosure;

FIG. 4 is a schematic representation of the internal operating components of the sexual stimulation device, in accordance with an embodiment of the present disclosure;

FIGS. 5A and 5B illustrate an exploded view of the sexual stimulation device depicting a second stimulation element, in accordance with an embodiment of the present disclosure;

FIG. 6A is a schematic representation of the internal operating components of the sexual stimulation device, in accordance with an embodiment of the present disclosure;

FIGS. 6B and 6C, illustrate the mounting of one or more stimulation elements of the sexual stimulation device, in accordance with an embodiment of the present disclosure;

FIGS. 7A and 7B illustrate a schematic representation of a second actuation member fluidically coupled to a second stimulation element through a valve assembly, in accordance with an embodiment of the present disclosure;

FIGS. 8A and 8B illustrate a schematic representation of a second actuation member fluidically coupled to a second stimulation element through a valve assembly, in accordance with an embodiment of the present disclosure;

FIG. 9A illustrates a schematic representation of the sexual stimulation device including the second actuation member operatively coupled to the accommodating element through the valve assembly, in accordance with an embodiment of the present disclosure;

FIG. 9B illustrates a schematic representation of the sexual stimulation device including the second actuation member operatively coupled to an accommodating chamber through the valve assembly, in accordance with an embodiment of the present disclosure;

FIG. 10 illustrates a schematic representation of a sexual stimulation device, in accordance with an embodiment of the present disclosure; and

FIGS. 11A and 11B illustrate a schematic representation of a sexual stimulation device, in accordance with an embodiment of the present disclosure.

The drawings referred to in this description are not to be understood as being drawn to scale except if specifically noted, and such drawings are only exemplary in nature.

FIG. 12 illustrate a schematic representation of a sexual stimulation device, in accordance with an embodiment of the present disclosure.

FIG. 13A illustrate a schematic representation of a five-channel valve assembly when its valve is in a first mode, in accordance with FIG. 12.

FIG. 13B illustrate a schematic representation of a five-channel valve assembly when its valve is in a second mode, in accordance with FIG. 12.

FIG. 13C illustrate a schematic representation of a five-channel valve assembly when its valve is in a third mode in accordance with FIG. 12.

FIG. 14A illustrate a schematic representation of a six-channel valve assembly when its valve is in a first mode.

FIG. 14B illustrate a schematic representation of a six-channel valve assembly when its valve is in a second mode.

FIG. 14C illustrate a schematic representation of a six-channel valve assembly when its valve is in a third mode.

FIG. 15A illustrate a schematic representation of a four-channel valve assembly when its valve is in a first mode.

FIG. 15B illustrate a schematic representation of a four-channel valve assembly when its valve is in a second mode.

FIG. 15C illustrate a schematic representation of a four-channel valve assembly when its valve is in a third mode.

FIG. 16. illustrate a schematic representation of a sexual stimulation device, in accordance with an embodiment of the present disclosure.

FIG. 17A illustrate a schematic representation of a four-channel valve assembly when its valve is in a first mode, in accordance with FIG. 16.

FIG. 17B illustrate a schematic representation of a four-channel valve assembly when its valve is in a second mode, in accordance with FIG. 16.

FIG. 17C illustrate a schematic representation of a four-channel valve assembly when its valve is in a third mode, in accordance with FIG. 16.

FIG. 17D illustrate a schematic representation of a four-channel valve assembly when its valve is in a fourth mode, in accordance with FIG. 16.

FIG. 18 illustrate a schematic representation of connection between a liquid chamber and a channel.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

Reference in this specification to “one embodiment” or “an embodiment” means that a particular feature, structure, or characteristic described in connection with the embodiment is included in at least one embodiment of the present disclosure. The appearances of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features.

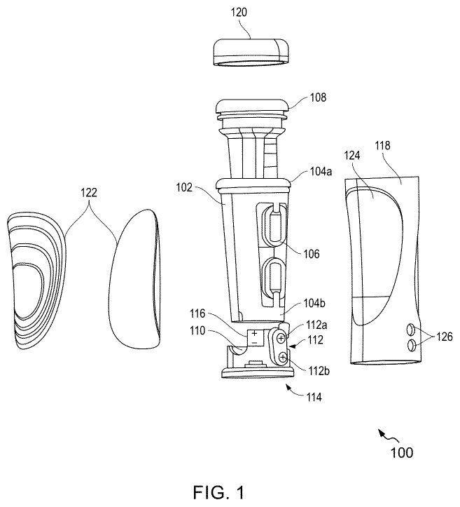

Various embodiments of the present invention are described hereinafter with reference to FIG. 1 to FIGS. 11A and 11B.

FIG. 1 illustrates an exploded view of a sexual stimulation device 100, in accordance with an embodiment of the present disclosure. The sexual stimulation device 100 may be configured with one or more operating features for providing sexual stimulation to a user. In the illustrated embodiment, the sexual stimulation device 100 may be a male masturbator configured to provide sexual stimulation to a male user. Alternatively, the sexual stimulation device may be used to provide sexual stimulation to any user irrespective of gender. In general, the sexual stimulation device 100 may be configured to mimic and/or imitate the inspiratory and expiratory effects of a human mouth for providing sexual stimulation and/or to provide sexual stimulation using the vibration feature. In other words, the sexual stimulation device 100 is designed to simulate realistic and satisfying masturbating experiences to users which is explained further in greater detail.

The sexual stimulation device 100 includes a housing 102. The housing 102 is configured to be a substantially hollow structure for accommodating one or more components of the sexual stimulation device 100. The housing 102 includes a proximal portion 104a and a distal portion 104b. In an embodiment, the housing 102 may be a unitary structure. In another embodiment, the housing 102 may be formed by detachably coupling one or more structures using suitable coupling means such as, but not limited to, screws, snap-fit arrangement, and so forth. The detachable configuration of the housing 102 allows access to components or elements housed inside the housing 102. For example, while adjusting or repairing any internal component or element housed within the housing 102. Further, the housing 102 may be made of suitable materials such as, but not limited to, plastic, metal, rubber, wood, and any combination thereof. Furthermore, the housing 102 may be made of suitable manufacturing techniques, for example, extrusion, molding, and so forth.

The sexual stimulation device 100 includes one or more stimulation elements 106 disposed in the housing 102. The stimulation elements 106 are configured to provide sexual stimulation to the user. The sexual stimulation device 100 further includes at least one actuation member disposed in the housing (not shown in FIG. 1). The actuation member is operatively coupled to the stimulation members for providing sexual stimulation to the user. In one embodiment, the stimulation elements 106 are integrated with the actuation member. The stimulation elements and the actuation members are integrated together as a component.

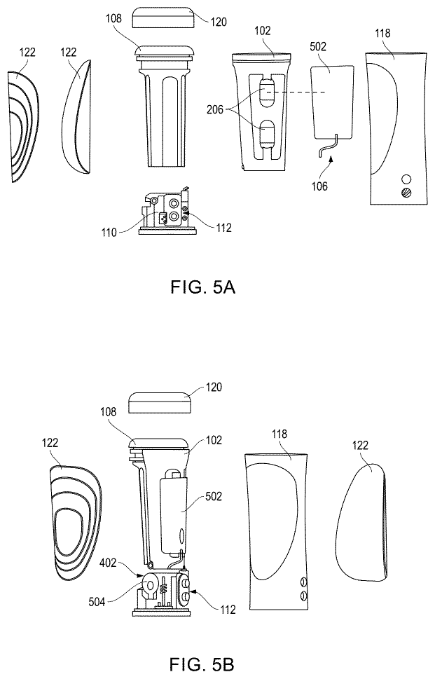

The sexual stimulation device 100 further includes an accommodating element 108. The accommodating element 108 is disposed in the housing 102 from the proximal portion 104a to the distal portion 104b. The accommodating element 108 is configured to receive a genital organ (e.g., penis) therein. Further, the accommodating element 108 projects out of the proximal portion 104a of the housing 102 when the accommodating element 108 is disposed in the housing 102 (as shown in FIG. 5B). The accommodating element 108 may be made of flexible materials such as, but not limited to, Thermoplastic elastomers (TPE).

The sexual stimulation device 100 further includes a control circuitry 110. The control circuitry 110 may be housed in the housing 102. In an embodiment, the control circuitry 110 may be communicably coupled to the sexual stimulation device 100 using wireless communication protocols. Further, the control circuitry 110 is configured to receive a control instruction via a communication interface (not shown in Figures). The control instruction is received based on inputs provided in at least one input interface 112. The input interface 112 is positioned in a bottom portion 114 of the sexual stimulation device 100. The input interface 112 is operatively coupled to the control circuitry 110 through a communication interface (e.g., wired connection). The user may apply force onto the input interface 112 for operating the sexual stimulation device 100. In other words, the user may press the input interface 112 to operate the sexual stimulation device 100. In this scenario, the input interface 112 transmits a control instruction to the control circuitry 110. The control instruction includes data related to a magnitude of force applied on the input interface 112. Thereafter, the control circuitry 110 determines operating parameters corresponding to data associated with the control instruction (i.e., the magnitude of force applied on the input interface 112). Further, the control circuitry 110 generates a control signal by appending the operating parameters and transmits the control signal to the actuation members. The control signal selectively operates the actuation members to activate the stimulation elements 106. Further, activating the stimulation elements 106 performs predefined actions corresponding to the operating parameters, thereby providing sexual stimulation to the user's body while the sexual stimulation is in contact with the user's body. The predefined actions may be a vibrotactile output or a squeezing action.

The sexual stimulation device 100 includes a power source 116. The power source 116 is disposed in the housing 102. The power source 116 is operatively coupled (e.g., wired connection) to the control circuitry 110, the stimulation elements 106, and the actuation members. The power source 116 is configured to provide electrical power to one or more operating components (for example, the stimulation elements 106, the control circuitry 110, the actuation members, etc.) of the sexual stimulation device 100. The power source 116 may be configured to provide an alternating current output or a direct current output. In an embodiment, the power source 116 includes a direct current power source, such as a rechargeable battery (for example, a lithium-ion (Li-on) battery), operable to provide the required electrical power for the operation of the stimulation elements 106 or the actuation members. Further, the power source 116 may include electrical and/or electronic components or circuits for enabling the use of wired or wireless charging. Alternatively, the power source 116 may include electrical and/or electronic components or circuits for enabling the use of alternating current to provide the required electrical power for the operation of the stimulation elements 106 and the actuation members.

The sexual stimulation device 100 includes an outer covering structure 118 and a top cover 120. The outer covering structure 118 is configured to encase the housing supporting the components of the sexual stimulation device 100. Further, the outer covering structure 118 may be mounted with at least one anti-skid structure 122 on at least a portion of the outer covering structure 118. In particular, the portion of the outer covering structure 118 may be defined with an accommodating space 124 for receiving the anti-skid structures 122. The anti-skid structures 122 may be configured with indentations to enhance the gripping of the sexual stimulation device 100. In addition, the outer covering structure 118 is configured with grooves 126. The input interface 112 is positioned in the grooves 126 when the outer covering structure 118 is secured onto the housing 102. In an embodiment, the anti-skid structures 122 may be integrally formed in the outer covering structure 118. Further, the top cover 120 is mounted to the proximal portion 104a. This allows the user to access the accommodating element 108 for cleaning purposes.

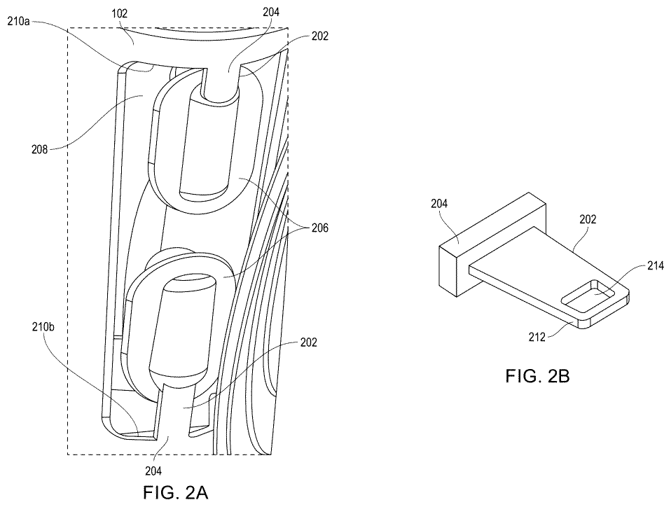

Referring to FIG. 2A in conjunction with FIG. 1, the sexual stimulation device 100 includes at least one linkage member 202. Further, each linkage member of the at least one linkage member 202 includes a first end 204 and a second end (see, 212 of FIG. 2B). The first end 204 is coupled to the housing 102. In particular, the housing 102 includes a cut-out portion 208. The at least one linkage member 202 is mounted at opposite sides of the cut-out portion 208 (as shown in FIG. 2A). The first end 204 is mounted to a first side 210a and a second side 210b of the cut-out portion 208. In other words, the first end 204 of the linkage members 202 laterally extends from each of the first side 210a and the second side 210b of the cut-out portion 208 defined in the housing 102. In an embodiment, the first end 204 of the linkage members 202 may be fixedly mounted (or integrated) to the housing 102. In another embodiment, the first end 204 of the linkage members 202 may be mounted to the housing 102 using conventional means such as adhesives, screws, etc.

Further, the second end 212 is disposed (freely) relative to the housing 102. The second end 212 may be operatively coupled to the stimulation elements 106. The stimulation elements 106 includes a first stimulation element 206. The first stimulation element 206 may include an installation structure (not shown in Figures) configured to couple with a complementary installation structure (see, 214 of FIG. 2B) of the linkage members 202. In an embodiment, the first stimulation element 206 and the linkage members 202 may be a unitary structure. The complementary installation structure 214 of the linkage members 202 depicted in FIG. 2B is for exemplary purposes. Further, the installation structure and the complementary installation structure 214 may be configured in any other configurations as per design feasibility and requirement.

Additionally, the at least one linkage member 202 and the first stimulation element 202 may include a conductive interface (not shown in Figures). The conductive interface may be similar to a magnetic charging interface or a magnetic strip. Thus, coupling the first stimulation element 206 with the linkage members 202 enables coupling (or magnetic coupling) of the conductive interface associated with the first stimulation element 206 and the linkage members 202. In other words, the linkage members 202 and the first stimulation element 206 may be electrically coupled to each other.

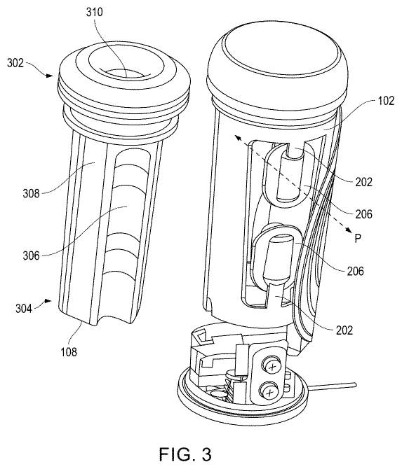

Referring to FIG. 3 in conjunction with FIG. 1, the accommodating element 108 includes a top portion 302, a bottom portion 304, and a recessed area 306. The top portion 302 is configured in an open configuration for allowing insertion of male genitalia (e.g., penis) therein. In other words, the top portion 302 includes a flexible opening 310 for receiving a penis of the user. It is to be noted that the top portion 302 is projected out of the housing 102 for receiving the male genitalia therein. The accommodating element 108 is configured to provide sexual stimulation due to a combined operation of the actuation members and the stimulation elements 106. In an embodiment, the top portion 302 of the accommodating element 108 may be configured to have a shape of a vagina to enable in creating desired sexual stimulus or arousal for the user while masturbating using the sexual stimulation device 100. In another embodiment, the top portion 302 may be configured to have a shape of an anus or multiple shapes (vagina, anus, or a combination thereof), or any other configurations as per the design feasibility and requirements.

It is to be understood that the size of the accommodating element 108 is to be designed such that it can receive therethrough penises of various sizes. Typically, the accommodating element 108 is a flexible and expandable configuration, adapted to adjustably contact and surround the penis based on the size thereof. In one example, the sexual stimulation device 100 may be provided with multiple accommodating elements, such as the accommodating element 108, each having a different size of the flexible opening at the top portion 302 to accommodate varying diametrical sizes of the penis. Further, the bottom portion 304 is configured to be a closed configuration.

The recessed area 306 is configured along at least a length of an outer wall 308 of the accommodating element 108. The recessed area 306 is configured in conformity with the structural configuration of the first stimulation element 206. The recessed area 306 is adapted to receive at least a portion of the first stimulation element 206. In this way, the first stimulation element 206 contacts the accommodating element 108 via the recessed area 306. The first stimulation element 206 is operated to provide sexual stimulation to the male genitalia inserted in the accommodating element 108. In this embodiment, the first stimulation element 206 is operated to provide sexual stimulation to the male genitalia against the accommodating element 108.

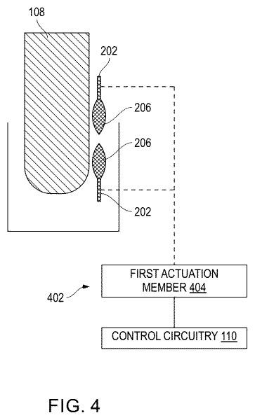

Referring to FIG. 4, the sexual stimulation device 100 includes at least one actuation member (see, 402). The actuation member 402 includes a first actuation member 404. The first actuation member 404 may include electric actuators (motor), piezoelectric actuators, and the like. The first actuation member 404 is operatively coupled to the at least one linkage member 202 and the control circuitry 110. The control circuitry 110 generates a control signal to operate the first actuation member 404. In particular, the control circuitry 110 generates a first control signal by appending operating parameters to operate the first actuation member 404. The operating parameters for the first control signal may include an operating intensity and an operating time. The operating time and the operating intensity may be determined based on the magnitude of force applied on a first input interface 112a of the input interface 112. The first control signal operates the first actuation member 404 which in turn operates the first stimulation element 206 to perform predefined actions to provide sexual stimulation while the sexual stimulation device is in contact with the user's body. Further, operating the first stimulation element 206 activates the at least one linkage member 202 moving in a predefined direction (see, direction ‘P’ in FIG. 3) relative to the housing 102 due to polarization of the at least one linkage member 202. To that effect, the first stimulation element 206 is activated to provide enhanced sexual stimulation while the sexual stimulation device 100 is in contact with the user's body. The first stimulation element 206 operating the predefined direction ‘P’ corresponds to the predefined direction of the linkage members 202. Further, the first stimulation element 206 operating in the predefined direction ‘P’ may provide a vibrotactile output to the male genitalia inserted in the accommodating element 108.

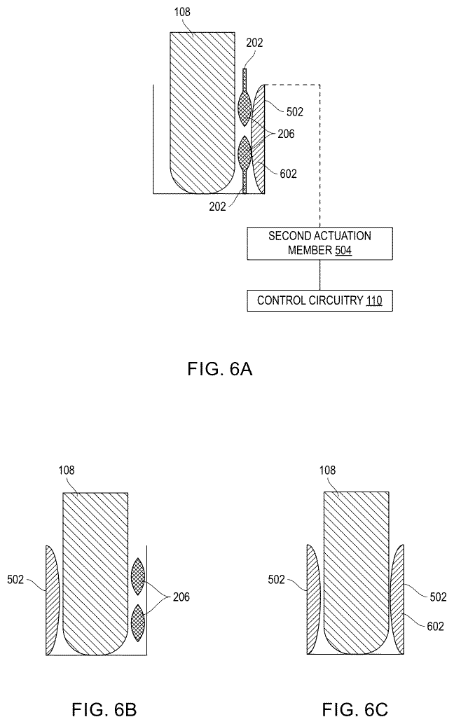

Referring to FIG. 5A, the one or more stimulation elements 106 includes a second stimulation element 502. The second stimulation element 502 encompasses at least a portion of the first stimulation element 206 and a portion of the accommodating element 108 of the sexual stimulation device 100. The second stimulation element 502 may be made of flexible materials. The second stimulation element 502 is configured to undergo elastic deformation. Further, a chamber (see, 602 of FIG. 6A) is defined between the second stimulation element 502 (i.e., the outer circumferential surface of the second stimulation element 502) and the first stimulation element 206. The chamber 602 is generally a hollow space or provides space therein. Further, it may be appreciated that the second stimulation element 502 may itself act as a chamber inside the housing 102. In the present examples, the second stimulation element 502 may be any suitable bag made of elastic material and able to withstand air pressures needed for inflation of the second stimulation element 502 to the required extent for compression of the accommodating element 108.

Referring to FIG. 5B, the actuation member 402 includes a second actuation member 504. The second actuation member 504 may include an air pump, piezoelectric pump, etc. The second actuation member 504 is disposed in the bottom portion 114 of the housing 102. The second actuation member 504 is operatively coupled to the control circuitry 110. The control circuitry 110 generates a control signal to operate the second stimulation element 502 between a compressed state and an expanded state. The second stimulation element 502 operated between the compressed state and the expanded state corresponds to the predefined actions of the second stimulation element 502. In other words, the control of inflation and deflation of the chamber 602 due to the operation of the second actuation member 504 (e.g., air pump) which will be explained further in detail.

Referring to FIG. 6A, the second stimulation element 502 encompasses at least a portion of the first stimulation element 206. In an embodiment, the second stimulation element 502 may encompass the portion of the first stimulation element 206 and a part of the accommodating element 108. The control circuitry 110 generates a second control signal by appending operating parameters to operate the second actuation member 504. The operating parameters may include operating pressure, operating frequency, and operating time. The operating time, the operating pressure, and the operating frequency may be determined based on the magnitude of force applied on a second input interface 112b of the input interface 112. The second control signal operates the second actuation member 504 which in turn operates the second stimulation element 502. To that effect, the second stimulation element 502 is operated between a compressed state and an expanded state. The second stimulation actuation 504 is fluidically coupled to the second stimulation element 502 and the ambient atmosphere. The second actuation member 504 operates the second stimulation element 502 in the expanded state by blowing out air from the ambient atmosphere within the chamber 602 of the second stimulation element 502 based on the operating pressure. Further, the second actuation member 504 operates the second stimulation element 502 in the compressed state by drawing air from within the chamber 602 of the second stimulation element 502. The second stimulation element 502 operating in the compressed state and the expanded state provides a squeezing action to the accommodating element 108, thereby providing sexual stimulation to the male genitalia inserted therein. In addition, the second stimulation element 502 operating in the compressed state and the expanded state activates the first stimulation element 206. Hence, a combined operation of the second stimulation element 502 and the first stimulation element 206 operates the accommodating element 108 to perform the predefined actions thereby enabling the accommodating element 108 to provide sexual stimulation to the user's body. In other words, the second stimulation element 502 is configured to undergo elastic deformation to provide squeezing action corresponding to the magnitude of force applied on the input interface 112 (i.e., the second input interface 112b).

In an embodiment, the second stimulation element 502 is disposed in the sexual stimulation device 100 such that the second stimulation element 502 encompasses only a portion of the accommodating element 108 (as shown in FIG. 6B). In other words, the second stimulation element 502 may adhere to an inner wall (not shown in Figures) of the outer covering structure 118. The second stimulation element 502 adhered to the inner wall of the outer covering structure 118 encompasses the portion of the accommodating element 108 when the outer covering structure 118 is secured to the housing 102. Thus, the first stimulation element 206 is located at one side of the accommodating element 108 and the second stimulation element 502 is located on another side of the accommodating element 108 (as shown in FIG. 6B). In another embodiment, only the second stimulation element 502 is disposed in the sexual stimulation device 100 (as shown in FIG. 6C). It is to be noted that two stimulation elements (i.e., the second stimulation element 502) are disposed on either side of the accommodating element 108. In both scenarios, the chamber 602 is defined between the second stimulation element 502 (i.e., the outer circumferential surface of the second stimulation element 502) and the portion of the accommodating element 108. Further, in both scenarios, the second stimulation element 502 operating between the expanded state and the compressed state directly impacts the accommodating element 108 to provide sexual stimulation to the male genitalia inserted therein.

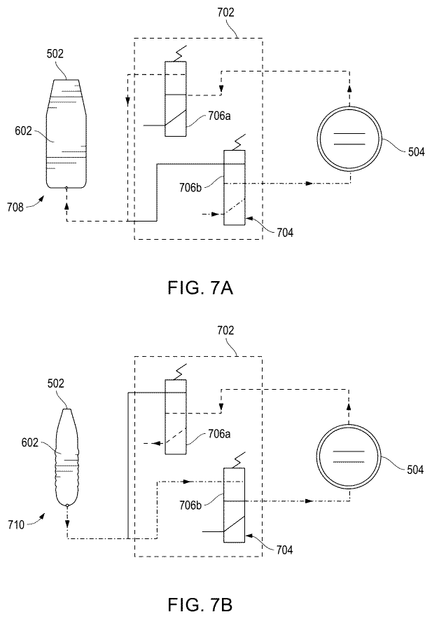

FIGS. 7A and 7B illustrate a schematic representation of the second actuation member 504 fluidically coupled to the second stimulation element 502 through a valve assembly 702, in accordance with an embodiment of the present disclosure. As shown, the second actuation member 504 is fluidically coupled to the second stimulation element 502 and the ambient atmosphere through the valve assembly 702. The valve assembly 702 may include a set of valves 704. The set of valves 704 is fluidically coupled to the second actuation member 504 and the second stimulation element 502 and operated in a first mode and a second mode to operate the second stimulation element 502 in the expanded state and the compressed state, respectively. Therefore, the second stimulation element 502 is configured to be alternately inflated and deflated (rapidly) through the valve assembly 702, and there is no need to manually deflate the air pressure of the second stimulation element 502. The rapid alternate inflation and deflation of the second stimulation element 502 can improve the stimulation effect of the sexual stimulation device 100.

The valve assembly 702 may be a dual-channel valve assembly (as shown in FIGS. 7A and 7B). In this example, the set of valves 704 of the valve assembly 702 includes a first valve 706a and a second valve 706b. The first valve 706a and the second valve 706b may be referred to as a first channel and a second channel. As shown in FIG. 7A, the first valve 706a is fluidically coupled to the second stimulation element 502 and the second actuation member 504, and the second valve 706b is fluidically coupled to the second actuation member 504 and the ambient atmosphere.

In the first mode, the first valve 706a (or the first channel) is configured to inflate the second stimulation element 502 and the second valve 706b (or the second channel) draws in (or inhales) air from the ambient atmosphere. In particular, the second actuation member 504 operates the second valve 706b to allow the inflow of air from the ambient atmosphere into the sexual stimulation device 100 (as shown in FIG. 7A). Thereafter, the second actuation member 504 operates the first valve 706a to route the inflow of air into the chamber 602 of the second stimulation element 502 (as shown in FIG. 7A). Thus, operating the second stimulation element 502 in an expanded state 708 (as shown in FIG. 7A).

In the second mode, the second valve 706b (or the second channel) is configured to inhale from the second stimulation element 502 and the first valve 706a (or the first channel) expels air to the ambient atmosphere. In particular, the second actuation member 504 operates the second valve 706a to draw out air from within the chamber 602 of the second stimulation element 502 (as shown in FIG. 7B). Thereafter, the second actuation member 504 operates the first valve 706a to route the air to the ambient atmosphere (as shown in FIG. 7B). Thus, operating the second stimulation element 502 in a compressed state 710 (as shown in FIG. 7B).

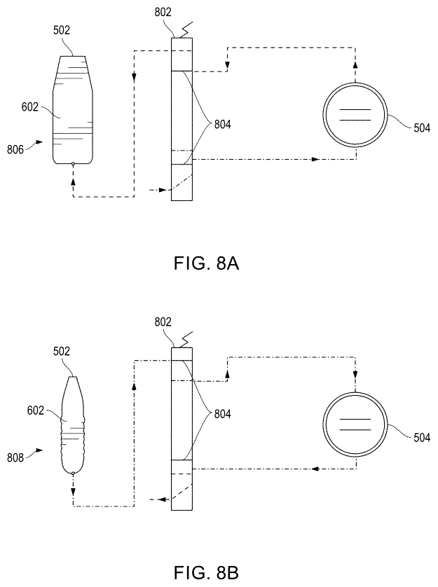

FIGS. 8A and 8B illustrate a schematic representation of the second actuation member 504 fluidically coupled to the second stimulation element 502 through a valve assembly 802, in accordance with another embodiment of the present disclosure. As shown, the second actuation member 504 is fluidically coupled to the second stimulation element 502 and the ambient atmosphere through the valve assembly 802. The valve assembly 802 may include a set of valves 804. The set of valves 804 is fluidically coupled to the second actuation member 504 and the second stimulation element 502 and operated in a first mode and a second mode to operate the second stimulation element 502 in the expanded state and the compressed state, respectively.

The valve assembly 802 may be a multi-channel valve assembly (as shown in FIGS. 8A and 8B). In this example, the set of valves 804 of the valve assembly 802 includes multiple valves configured to regulate the air pressure in the second stimulation element 502. Similar to the valve assembly 702, the valve assembly 802 is configured to operate in the first mode and the second mode to cause the second stimulation element to operate in the expanded state (see, 806 of FIG. 8A) and the compressed state (see, 808 of FIG. 8B).

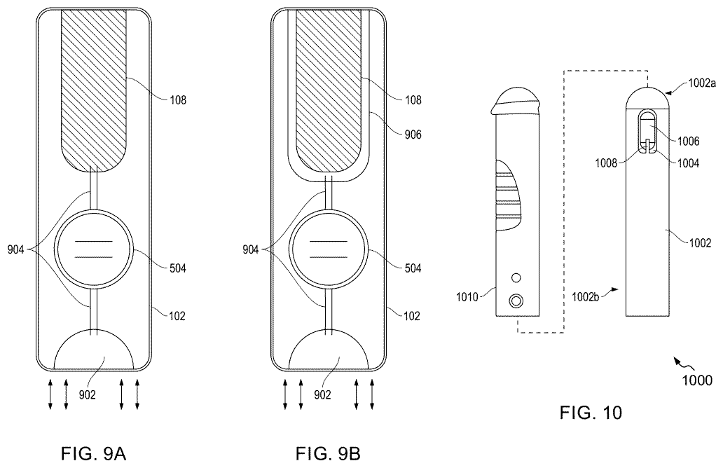

FIG. 9A illustrates a schematic representation of the second actuation member 504 operatively coupled to the accommodating element 108, in accordance with an embodiment of the present disclosure. As shown, the housing 102 is configured with a ventilation chamber 902. The ventilation chamber 902 is located at a bottom portion 114 of the sexual stimulation device 100. Alternatively, the ventilation chamber 902 may be configured at any location in the sexual stimulation device 100 as per the design feasibility and requirements.

The ventilation chamber 902 is maintained at an ambient air pressure condition. The ventilation chamber 902 may be fluidically coupled to ambient atmosphere. Alternatively, the ambient atmosphere may be the ventilation chamber 902. In particular, the ventilation chamber 902 is adapted to allow the inflow and outflow of air to and from the sexual stimulation device 100, respectively. Further, the second actuation member 504 is fluidically coupled to the accommodating element 108 via a valve assembly 904. The valve assembly 904 is an example of the valve assembly 802 or the valve assembly 702. In this scenario, the accommodating element 108 may act as the stimulation element (i.e., the stimulation elements 206 and/or the stimulation elements 502) for providing sexual stimulation to the male genitalia inserted therein. Further, the second actuation member 504 is configured to regulate the air pressure of the accommodating element 108 through the valve assembly 902 to cause the accommodating element 108 to provide sexual stimulation. Similar to the second stimulation element 502, the accommodating element 108 may undergo elastic deformation (or provide squeezing action) due to the flexible nature of the accommodating element 108. In an embodiment, the accommodating element 108 expels the air within the accommodating element 108 due to the operation of the second actuation member 504. This may result in the accommodating element 108 being compressed. Further, the second actuation member 504 operates the accommodating element 108 to draw in air from the ambient atmosphere to cause the accommodating element 108 to be expanded. It should be noted that the inflow and outflow of air to and from the accommodating element 108 is due to the flexible opening 310 at the top portion 302 of the accommodating element 108. The squeezing action of the accommodating element 108 is due to the flexible opening 310 at the top portion 302 of the accommodating element 108. Further, the male genitalia inserted in the accommodating element 108 causes the opening 302 to be closed.

FIG. 9B illustrates a schematic representation of the second actuation member 504 operatively coupled to an accommodating chamber 906 of the sexual stimulation device 100, in accordance with an embodiment of the present disclosure. As shown, the second actuation member 504 is fluidically coupled to the accommodating chamber 906 via the valve assembly 904. The accommodating chamber 906 may be made of flexible materials. Further, the accommodating element 108 is disposed in the accommodating chamber 906. The valve assembly 904 is an example of the valve assembly 802 or the valve assembly 702. In this scenario, the accommodating element 108 may act as the stimulation element (i.e., the stimulation elements 206 and/or the stimulation elements 502) for providing sexual stimulation to the male genitalia inserted therein. Further, the second actuation member 504 is configured to regulate the air pressure of the accommodating chamber 906 through the valve assembly 902 to cause the accommodating element 108 to provide sexual stimulation. Similar to the second stimulation element 502, the accommodating element 108 and the accommodating chamber 906 may undergo elastic deformation (or provide squeezing action) due to the flexible nature of the accommodating element 108 and the accommodating chamber 906. In an embodiment, the accommodating chamber 906 expels the air from within the accommodating chamber 906 due to the operation of the second actuation member 504. This results in the accommodating chamber 906 being compressed. Further, the second actuation member 504 operates the accommodating chamber 906 to draw in air from the ambient atmosphere to cause the accommodating chamber 906 to be expanded. It should be noted that the inflow and outflow of air to and from the accommodating chamber 906 cause the accommodating element 108 to provide squeezing action, thereby providing sexual stimulation to the male genitalia inserted therein.

In an embodiment, the second actuation member 504 is fluidically coupled to the ventilation chamber (such as the ventilation chamber 906), and the second stimulation element 506 through the valve assembly 904.

FIG. 10 illustrates a schematic representation of a sexual stimulation device 1000, in accordance with an embodiment of the present disclosure. The sexual stimulation device 1000 may be a female sexual stimulation device. Some examples of the female sexual stimulation device may include, but not limited to, a dildo, vibrator, etc. Similar to the sexual stimulation device 100, the sexual stimulation device 1000 includes a housing 1002. The housing 1002 is configured to be a substantially hollow structure for accommodating one or more components of the sexual stimulation device 1000. Further, the housing 1002 may be made of suitable materials such as, but not limited to, plastic, metal, rubber, wood, and any combination thereof. Furthermore, the housing 1002 may be made of suitable manufacturing techniques, for example, extrusion, molding, and so forth.

The sexual stimulation device 1000 includes one or more stimulation elements 1006 disposed in the housing 1002. In particular, the housing 1002 includes a cut-out portion 1004 configured at a proximal portion 1002a of the housing 1002. The stimulation elements 1006 are disposed in the housing 1002 and positioned in the cut-out portion 1004. The stimulation elements 1006 is an example of the first stimulation element 206. This enables the stimulation elements 1006 to be in contact with the user's body when the sexual stimulation device 1000 is inserted in the female genitalia (e.g., vagina) or anus. It is to be noted that the stimulation elements 1006 are mounted to at least one linkage member 1008. The structural configuration of the stimulation elements 1006 mounted to the linkage members 1008 are similar to the stimulation elements 106 and the linkage members 202, therefore they are not reiterated herein for the sake of brevity. Further, the sexual stimulation device 1000 may include a flexible element 1010 configured to be removably secured onto the housing 1001. The flexible element 1010 may be made of silicone. The flexible element 1010 is configured to contact the user's body and provide sexual stimulation to the user's body when the sexual stimulation device 1000 is inserted in the female genitalia. In this embodiment, the stimulation elements 1006 are adapted to provide sexual stimulation to the user's body against the flexible element 1010. Furthermore, the sexual stimulation device 1000 may include a control circuitry, at least one actuation member, and a power source (not shown in Figures). The control circuitry, the actuation members, and the power source may be disposed at a bottom portion 1002b of the housing 102. The components (e.g., the control circuitry, the actuation members, the stimulation elements 1006) of the sexual stimulation device 1000 may be configured to perform similar operations as explained with reference to the sexual stimulation device 100.

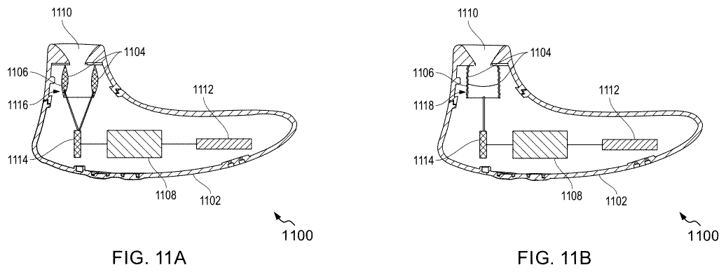

FIGS. 11A and 11B illustrate a schematic representation of a sexual stimulation device 1100, in accordance with an embodiment of the present disclosure. The sexual stimulation device 1100 may be a suction device or a pressure field stimulation device. The sexual stimulation device 1100 may be configured to produce suction action or modifiable pressure field for providing sexual stimulation to the user's body. The sexual stimulation device 1100 includes a housing 1102 and one or more stimulation elements 1104 including a chamber 1106. The stimulation elements 1104 are similar to the second stimulation element 502. The stimulation elements 1104 are made of flexible materials and are configured to undergo elastic deformation. Further, the sexual stimulation device 1110 includes a cavity 1110 to contact with the user's body. The chamber 1106 and the cavity 1110 are in fluid communication. In another scenario, the chamber 1106 and the cavity 1110 can be regarded as one component. In yet another scenario, the cavity 1110 may include an opening configuration for enabling contact with user's body, such as clitoris.

The sexual stimulation device 1100 further includes at least one actuation member 1108. The actuation member 1108 is fluidically coupled to the stimulation elements 1104 through a valve assembly 1114. The actuation member 1108 and the valve assembly 1114 are examples of the second actuation member 504 and the valve assembly 702, 802 respectively. Further, the actuation members 1108 may be operatively coupled to a control circuitry 1112. The control circuitry 1112 is similar to the control circuitry 110. Further, the control circuitry 1112 is configured to operate the actuation member 1108 to regulate the air pressure of the stimulation elements 1104. In one scenario, the actuation member 1108 operates the stimulation elements 1104 in an expanded state (see, 1116 of FIG. 11A) by inflating the chamber 1106. In this scenario, the volume of the cavity 1110 is reduced which will produce a negative pressure effect in the cavity 1110. In another scenario, the actuation member 1108 operates the stimulation elements 1104 in a compressed state (see, 1118 of FIG. 11B) by inhaling (or drawing out) air from within the chamber 1106. As a result, the stimulation 1104 elements are deformed, and the volume of the cavity 1110 increases, which will produce a positive pressure effect in the cavity 1110. Thus, by alternately inflating and deflating the chamber 1106, the volume of the cavity 1110 increases or decreases, thereby forming a stimulation effect of positive and negative pressure at the opening where the cavity 1110 contacts the user's body.

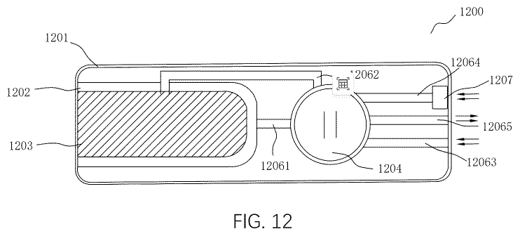

FIG. 12 illustrate a schematic representation of a sexual stimulation device 1200, in accordance with an embodiment of the present disclosure. The sexual stimulation device 1200 includes an accommodating element 1203 (similar to the accommodating element 108 in Figure. 9), a valve assembly and an actuation member 1204. The accommodating element 1203 is configured for allowing insertion of male genitalia therein. The valve assembly includes at least a valve, a first channel and a second channel. The actuation member 104 is configured to operate the valve at least in a first mode and a second mode, so as to fluidically couple an external ambience to an inside or a surrounding of the accommodating element 1203 through the valve assembly. The actuation member 1204 is also configured to operate the valve in the first mode to allow a first fluid flow through the first channel between the inside or the surrounding of the accommodating element 1203 and the external ambience, and operate the valve in the second mode to allow a second fluid flow through a second channel between the inside or the surrounding of the accommodating element 1203 and the external ambience. And the first fluid flow and the second fluid flow are separately controllable. In this way, the actuation member 104 and valve assembly enable independent adjustment of the fluid flow inside the accommodating element 1203 or surroundings thereof, ensuring precise and separate regulation of fluid dynamics, thereby improving the sexual stimulation device's operational flexibility, reliability, and efficiency while minimizing interference between different fluid flows.

It is worth mentioning that the term “external ambience” here does not specifically refer to a particular external component, but can encompass various external elements such as ambient atmosphere, liquid chamber or waste liquid collector, and so on. The term here “a first fluid flow” and “a second fluid flow” do not merely refer to different types of fluids, but can include either distinct fluid categories (such as air and liquid, lubricating oil and cleaning fluid, etc.) and different flow directions of the fluid (for example, inflow and outflow air, inflow and outflow liquid, inflow air and outflow liquid, etc.).

Further, the actuation member is operatively coupled to a control circuitry. The sexual stimulation device 1200 further includes a housing 1201 and the accommodating element 1203 is disposed in the housing 1201.

Further, the first fluid flow and the second fluid flow are different in at least one or more aspects among fluid type, fluid flow direction and fluid flow velocity. Thus, the type of fluid, the direction of fluid flow, and/or the velocity of fluid flow are controllably adjustable, and each parameter is independently configurable based on operational demands. The first mode and the second mode are different in at least one or more aspects among position of the valve, control of fluid flow direction and control of fluid flow velocity. As a result, distinct fluid flows can be independently controlled by modulating the modes of the valve.

Further, the accommodating element 1203 is operated alternating compressed and expanded without automatic compensation of air pressure difference. The design enables easier fluid flow rate adjustment, particularly rapid deflate, with significantly reduced internal pressure and improving compression tolerance.

In an embodiment, the accommodating element 1203 is operated in a compressed state when the valve is in the first mode, and the accommodating element 1203 is operated in an expanded state when the valve is in the second mode. Further, the accommodating element 1203 is operated in a wetted state when the valve is in the first mode or the second mode. More specifically, a wetted state may be a lubricated state or a washed state.

In an embodiment, the sexual stimulation device 1200 further includes a deformable element 1202 (for example, similar to the accommodating chamber 906 in Figure. 9B, or similar to the second stimulation element 502 in FIG. 4 to FIG. 8). The deformable element 1202 is configured be operated between a compressed state and an expanded state, and is configured to surround the accommodating element 1203, the deformable element 1202 the accommodating element 1203 are both fluidically coupled to the external ambience through the valve assembly. The term “surround” here does not only mean that deformable element 1202 encircles the accommodating element 1203, but also includes situations where the deformable element 1202 is located beside the accommodating element 1203, similar the FIG. 6. Also, the deformable element is configured to undergo elastic deformation through flowing of the fluid.

Further, the inside of the accommodating element 1203 is configured to at least fluidically couple to a liquid chamber 1207 containing liquid through the valve assembly. As an optional approach, the liquid chamber is configured for storing lubricating oil or water or cleaning liquid. In this way, liquid such as lubricating oil or water or cleaning liquid, can be imported by the valve assembly, thereby achieving lubrication of male genitalia or cleaning of accommodating element 1203.

In an embodiment, the deformable element 1202 is operated in an expanded state when the valve is in the first mode and the deformable element 1202 is operated in a compressed state when the valve is in the second mode. At this time, the accommodating element 1203 is operated in a compressed state when the valve is in the first mode, and the accommodating element 1203 is operated in an expanded state when the valve is in the second mode. Thus, the deformable element 1202 provides a squeezing action to the accommodating element 1203, thereby providing sexual stimulation to the male genitalia inserted therein. In another embodiment, the accommodating element 1203 can be deposited in a non-deformable accommodating chamber. In this scenario, the accommodating element 1203 can also be operated in a compressed state and an expanded state with flowing of the fluid when a closed space is formed between the accommodating element 1203 and the non-deformable accommodating chamber.

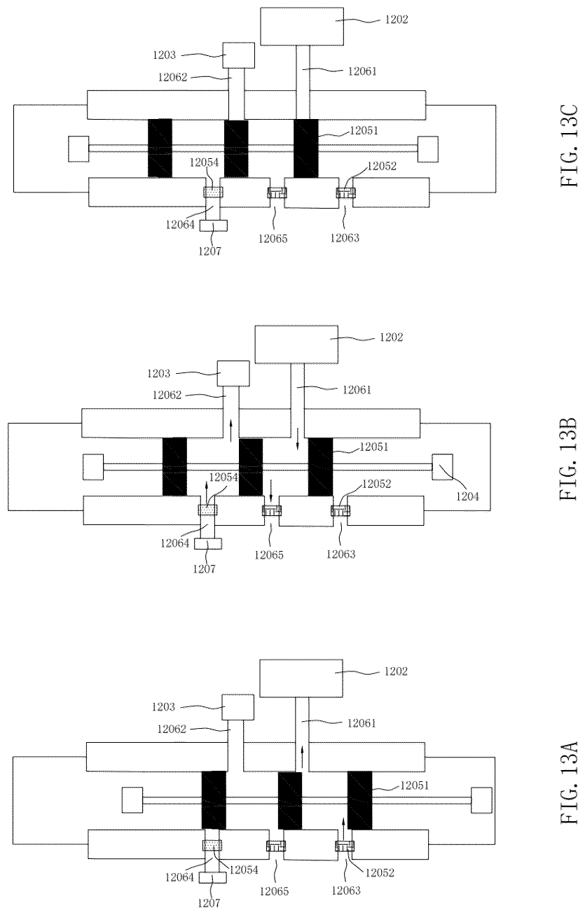

In accordance with an embodiment of the present disclosure, as shown in FIG. 12 and FIG. 13A to FIG. 13C, the actuation member operates the valve in the first mode to allow inflow of air to the deformable element 1202 and operates the valve in the second mode to allow outflow of air from the deformable element 1202 to the ambient atmosphere while allowing inflow of liquid to the accommodating element 1203. In this scenario, the deformable element 1202 is configured to be inflated and/or deflated through the valve assembly to stimulate the accommodating element 1203 at least in the first mode, and the accommodating element 1203 is configured at least to be imported liquid through the valve assembly in the second mode.

In one implementation, refer to FIG. 12, FIG. 13A, FIG. 13B and FIG. 13C again, the valve assembly may be a five-channel valve assembly including a first channel 12061, a second channel 12062, a third channel 12063 a fourth channel 12064 and a fifth channel 12065, wherein the first channel 12061, the second channel 12062 and the fourth channel 12064 are configured to be respectively coupled to the deformable element 1202, the accommodating element 1203, and a liquid chamber 1207 (e.g., a liquid container configured for storing lubricating oil or water or cleaning liquid), the third channel 12063 and the fifth channel 12065 are both coupled to ambient atmosphere. As shown in FIG. 13 A, air from the ambient atmosphere enters the valve assembly through the third channel 12063 and then enters the deformable element 1202 through the first channel 12061 to inflate the deformable element 1202 when the valve of the valve assembly is in the first mode. As shown in FIG. 13B, liquid from the liquid chamber 1207 enters the valve assembly through the fourth channel 12064 and then enters the accommodating element 1203 through the second channel 12062 when the valve of the valve assembly is in the second mode. In this scenario, in terms of the deformable element 1202, it is operated in a compressed state and the expanded state and provides a squeezing action to the accommodating element 1203 thereby providing sexual stimulation to the male genitalia inserted therein. In terms of the accommodating element 1203, it can be lubricated or cleaned by liquid from the liquid chamber 1207 and is stimulated by the deformable element 1202. The five-channel valve assembly is also configured to enable the air flows out from the deformable element 1202 through the first channel 12061 and the fifth channel 12065 in sequence when the valve is in the second mode to deflate the deformable element 1202, as in shown in FIG. 13B. Besides, as shown in FIG. 13C, the valve of the five-channel valve assembly can be in a mode of closing, that is to say, the valve is closed when it is in a third mode.

Obviously, the inflation and deflation of the deformable element 1202, as well as the lubrication or cleaning of accommodating element 1203 are achieved through the valve assembly and the actuator member, thereby realizing a stimulation function and lubrication or cleaning function for the accommodating element 1203. Moreover, the air channel and the liquid channel are completely independent and do not interfere with each other, ensuring the efficiency of expansion and compression of deformable element 1202 to the fullest extent.

The valve can include solenoid valve or air pump valve or piston valve or ball valve. In this embodiment, as shown in FIG. 13A to FIG. 13C, the valve includes a set of piston valves 12051 and air pump valves 12052 and a liquid pump valve 12054. The actuation member 1204 is a driving component configured to adjust the modes of the valve. For example, as shown in FIG. 13A to FIG. 13C, the actuating element 12054 operates the modes of the valve by adjusting the position of the piston valves 12051, starting or closing or adjusting directions of the air pump valves 12052 and the liquid pump valve 12054. The actuation method of the actuating element 1204 can be electric drive, pneumatic drive (like air pump), electromagnetic drive, etc.

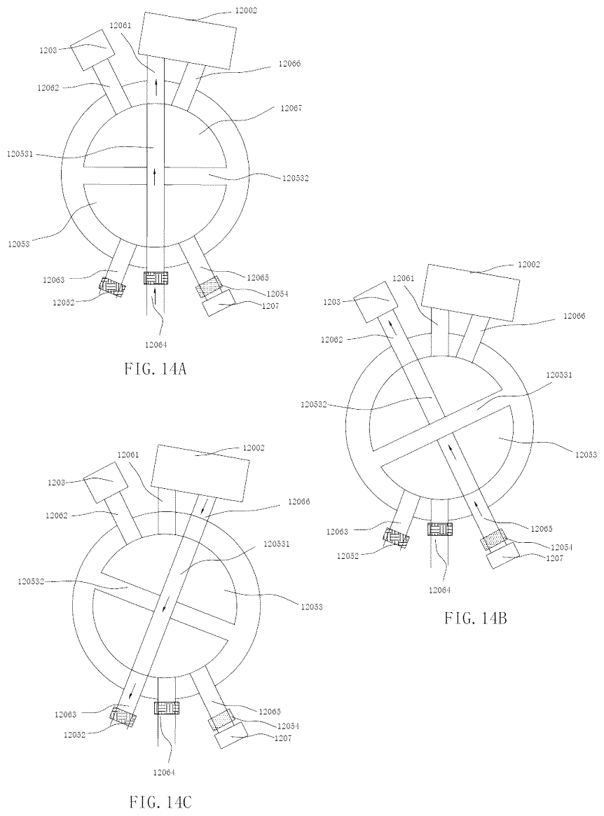

In another implementation, the valve is further configured to be operable in more modes, wherein the valve is configured allow outflow of the air from the deformable element 1202 to the external ambience. As shown in FIG. 14A, FIG. 14B and FIG. 14C, the valve assembly may be a six-channel valve assembly including a first channel 12061, a second channel 12062, a third channel 12063, a fourth channel 12064, a fifth channel 12065 and a sixth channel 12066, wherein the first channel 12061 and the sixth channel 12066 are both configured to couple to the deformable element 1202, the third channel 12063 and the fourth channel 12064 are both configured to couple to ambient atmosphere, the second channel 12062 and the fifth channel 12065 are configured to be respectively couple to the accommodating element 1203 and a liquid chamber 1207. In this implementation, the valve of the valve assembly includes a rotatable ball valve 12053 and a set of air pump valves 12052 and a liquid pump valve 12054. The rotatable ball valve 12053 comprises a first cavity channel 120531 and a second cavity channel 120532 independent of the first cavity channel 120531. As shown in FIG. 14A to FIG. 14C, the actuating element operates the modes of the valve by adjusting the rotation position of the ball valve 12053, starting or closing the air pump valves 12052 and the liquid pump valve 12054 and adjusting directions of the air pump valves 12052 and liquid pump 12054.

As shown in FIG. 14A, air from the ambient atmosphere enters the deformable element 1202 through the fourth channel 12064, the first cavity channel 120531 and the first channel 12061 in sequence to inflate the deformable element 1202 when the valve of the valve assembly is in the first mode. As shown in FIG. 14B, liquid from the liquid chamber 1207 enters the accommodating element 1203 through the fifth channel 12065, the second cavity channel 120532 and the second channel 12062 in sequence when the valve is in the second mode. As shown in FIG. 14C, air flows out from the deformable element 1202 to the ambient atmosphere through the sixth channel 12066, the first cavity channel 120531 and the third channel 12063 in sequence when the valve is in the third mode to deflate the deformable element 1202. In this scenario, it can also realize stimulation function and lubrication or cleaning function for the accommodating element 1203.

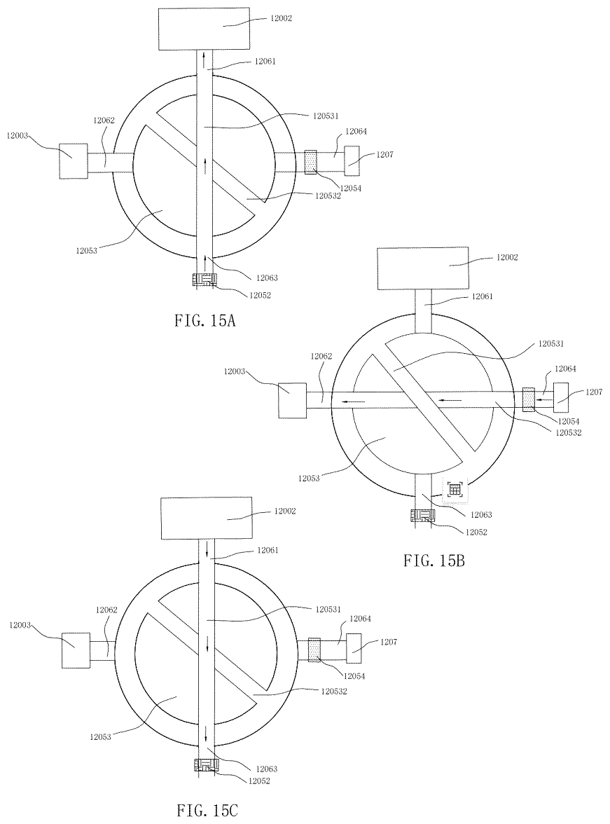

In another implementation, as shown in FIG. 15A, FIG. 15B and FIG. 15C, the valve assembly may be a four-channel valve assembly including a first channel 12061, a second channel 12062, a third channel 12063, and a fourth channel 12064, wherein the first channel 12061, the second channel 12062, the third channel 12063 and the fourth channel 12064 are configured to be respectively coupled to the deformable element 1202, the accommodating element 1203, ambient atmosphere, and a liquid chamber 1207. In this implementation, the valve of the valve assembly includes a rotatable ball valve 12053 and an air pump valve 12052 and a liquid pump valve 12054. The rotatable ball valve 12053 comprises a first cavity channel 120531 and a second cavity channel 120532 independent of the first cavity channel 120531. The valve of the four-channel valve assembly is configured to at least be operable in a first mode, a second mode and a third mode.

As shown in FIG. 15A, air from the ambient atmosphere enters the deformable element 1202 through the third channel 12063, the first cavity channel 12051 and the first channel 12061 in sequence to inflate the deformable element 1202 when the valve of the valve assembly is in the first mode. As shown in FIG. 15B, liquid from the liquid chamber 1207 enters the accommodating element 1203 through the fourth channel 12064, the second cavity channel 120532 and the second channel 12062 when the valve is in the second mode. As shown in FIG. 15C, air can flow out from the deformable element 1202 to the ambient atmosphere through the first channel 12061, the first cavity channel 120531 and the third channel 12063 in sequence to deflate the deformable element 1202 when the valve in a third mode. In this implementation, the difference between the third mode and the first mode is adjustment direction of the air pump valve 1202. In this scenario, it can also realize stimulation function and lubrication or cleaning function for the accommodating element 1203. Further, if it is necessary, liquid can also flow out from the accommodating element 1203 to liquid chamber 1207 through the second channel 12062, the second cavity channel 120532 and the fourth channel 12064 in sequence when the valve is in a fourth mode, the difference between the second mode and the fourth mode is also just adjustment direction of the air pump valve 12052.

Further, one or more stimulation elements (e.g., the first stimulation element 206) is configured to the closely adhere to the accommodating element 1203 to stimulate male genitalia therein, and intensity of stimulation applied by the stimulation element to the accommodating element 1203 increases when the deformable element 1202 is inflated.

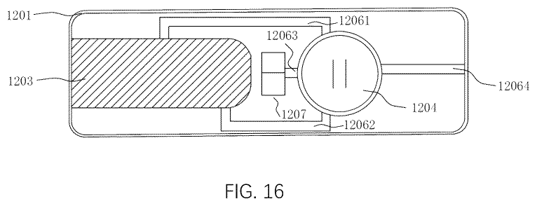

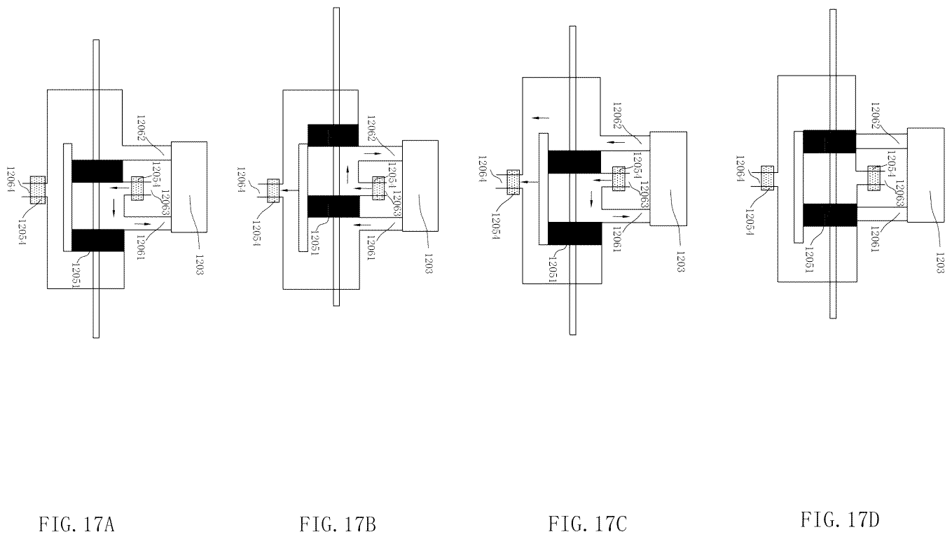

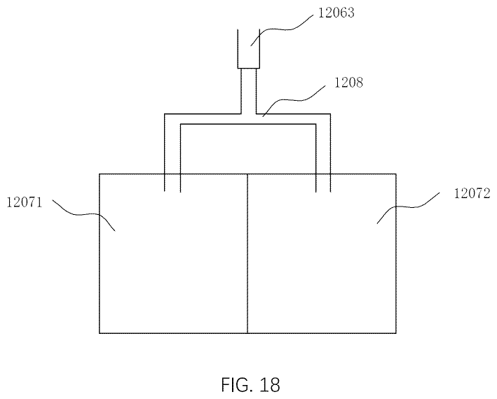

In accordance with an embodiment of the present disclosure, as shown in FIG. 16, FIG. 17A to 17C, and FIG. 18, the inside of the accommodating element 1203 is fluidically coupled to the external ambience through the valve assembly. The external ambience at least includes a first liquid chamber 12071 containing a first type of liquid and a second liquid chamber 12072 containing s second type of liquid (as shown in FIG. 18), the actuation member 1204 operates the valve in the first mode to allow inflow of the first type of liquid, and operates the valve in the second mode to allow inflow of the second type of liquid. For example, the accommodating element 1203 is operated in a lubricated state when the valve is in the first mode, and the accommodating element 1203 is operated in a washed state when the valve is in the second mode.

Further, the external ambience can further include a third liquid chamber (not shown in FIGS), the actuation member 1204 operates the valve in a third mode to allow outflow of the second type of liquid to the third liquid chamber, or the actuation member operates the valve in a fourth mode to allow outflow of the first type of liquid to the third liquid chamber.

Refer to FIG. 16, FIG. 17A, FIG. 17B and FIG. 17C again, the valve assembly may be a four-channel valve assembly including a first channel 12061, a second channel 12062, a third channel 12063, and a fourth channel 12064, wherein the first channel 12061 and the second channel 12062 are both configured to couple to the accommodating element 1203, the fourth channel is configured to couple to a third liquid chamber (e.g., a waste liquid collector), the third channel 12063 is configured to couple to a liquid chamber 1207 which is configured to store at least a first type of liquid and a second type of liquid. For example, as shown in FIG. 18, the first type of liquid is lubricating oil which is contained in the first liquid chamber 12071, and the second type of liquid is cleaning liquid which is contained in the second liquid chamber 12072. the first liquid chamber 12071 and the second liquid chamber 12071 are both fluidically couple to the third channel 12063 through a three-way pipe 1208.

In accordance with an embodiment of the present disclosure, the lubricating oil from the liquid chamber 1207 (e.g., from the first liquid chamber 12071) enters the accommodating element 1203 through the third channel 12063 and the first channel 12061 in sequence when the valve is in the first mode, as shown in FIG. 17A. The cleaning liquid from the liquid chamber 1207 (e.g., from the second liquid chamber 12072) enters the accommodating element 1203 through the third channel 12063 and the second channel 12062 in sequence when the valve is in the second mode, as shown in FIG. 17B. In this scenario, lubrication function and cleaning function for accommodating element 1203 are achieved through the valve assembly. Alternatively, the valve can be configured to be operated by the actuation member 1204 to both allow inflow of the lubricating oil and outflow of cleaning liquid when the valve is in the first mode, or the valve can be configured to be operated by the actuation member 1204 to both allow outflow of the lubricating oil and inflow of cleaning liquid when the valve is in the second mode, as shown in FIG. 17.B and FIG. C, thereby achieving fully automatic lubrication-drainage and fully automatic cleaning. Alternatively, the valve assembly can be configured to be operated by the actuation member 1204 to just allow outflow of one of the lubricating oil and cleaning liquid. As shown in FIG. 17D, the valve of the five-channel valve assembly can be operated in a fourth mode which is a mode of closing.

In another embodiment, a sexual stimulation device used to act on a user's orifice or surroundings thereof is disclosed. The valve assembly includes at least a valve, a first channel and a second channel. The actuation member is configured to operate the valve at least in a first mode and a second mode, so as to fluidically couple an external ambience to the orifice or the surroundings thereof through the valve assembly. The actuation member is configured to operate the valve in the first mode to allow a first fluid flow through the first channel between the orifice or the surroundings thereof and the external ambience, and operate the valve in the second mode to allow a second fluid flow through the second channel between the orifice or the surroundings thereof and the external ambience. The first fluid flow and the second fluid flow are separately controllable. In this way, the actuation member 104 and valve assembly enable independent adjustment of the fluid flow acted on the user's orifice or the surroundings thereof, ensuring precise and separate regulation of fluid dynamics, thereby improving the sexual stimulation device's operational flexibility, reliability, and efficiency while minimizing interference between different fluid flows.

In one implementation, the first fluid flow and second fluid flow produce at least one or more stimulation among lubrication, cleaning, expansion, and compression for the orifice or the surroundings thereof. The stimulation can be act on the orifice or the surroundings thereof of a male or female. For example, the external ambience is fluidically coupled a clitoris of the user through the valve assembly, resulting in stimulation on the clitoris.

Various embodiments of the disclosure, as discussed above, may be practiced with steps and/or operations in a different order, and/or with hardware elements in configurations, which are different than those which are disclosed. Therefore, although the disclosure has been described based upon these exemplary embodiments, it is noted that certain modifications, variations, and alternative constructions may be apparent and well within the spirit and scope of the disclosure.

Although various exemplary embodiments of the disclosure are described herein in a language specific to structural features and/or methodological acts, the subject matter defined in the appended claims is not necessarily limited to the specific features or acts described above. Rather, the specific features and acts described above are disclosed as exemplary forms of implementing the claims.

What is claimed is:

1. A sexual stimulation device, comprising:
an accommodating element configured for allowing insertion of male genitalia therein;
a valve assembly including at least a valve, a first channel and a second channel; and
an actuation member configured to operate the valve at least in a first mode and a second mode, so as to fluidically couple an external ambience to an inside or a surrounding of the accommodating element through the valve assembly;
wherein the actuation member is configured to operate the valve in the first mode to allow a first fluid flow through the first channel between the inside or the surrounding of the accommodating element and the external ambience, and operate the valve in the second mode to allow a second fluid flow through the second channel between the inside or the surrounding of the accommodating element and the external ambience,
and wherein the first fluid flow and the second fluid flow are separately controllable.

2. The sexual stimulation device as claimed in claim 1, wherein the first fluid flow and the second fluid flow are different in at least one or more aspects among fluid type, fluid flow direction and fluid flow velocity.

3. The sexual stimulation device as claimed in claim 1, wherein the first mode and the second mode are different in at least one or more aspects among position of the valve, control of fluid flow direction and control of fluid flow velocity.

4. The sexual stimulation device as claimed in claim 1, wherein the accommodating element is operated alternating compressed and expanded without automatic compensation of air pressure difference.

5. The sexual stimulation device as claimed in claim 1, wherein the external ambience at least includes ambient atmosphere, liquid chamber or waste liquid collector.

6. The sexual stimulation device as claimed in claim 1, wherein the valve includes solenoid valve or air pump valve or piston valve or ball valve.

7. The sexual stimulation device as claimed in claim 1, wherein the accommodating element is operated in a compressed state when the valve is in the first mode, and the accommodating element is operated in an expanded state when the valve is in the second mode.

8. The sexual stimulation device as claimed in claim 7, wherein the accommodating element is operated in a wetted state when the valve is in the first mode or the second mode.

9. The sexual stimulation device as claimed in claim 1, wherein the accommodating element is operated in a lubricated state when the valve is in the first mode, and the accommodating element is operated in a washed state when the valve is in the second mode.

10. The sexual stimulation device as claimed in claim 1, wherein a deformable element configured be operated between a compressed state and an expanded state is configured to surround the accommodating element, the deformable element and the accommodating element are both fluidically coupled to the external ambience through the valve assembly.

11. The sexual stimulation device as claimed in claim 10, wherein the actuation member operates the valve in the first mode to allow inflow of air to the deformable element and operates the valve in the second mode to allow outflow of air from the deformable element to the ambient atmosphere while allowing inflow of liquid to the accommodating element.

12. The sexual stimulation device as claimed in claim 10, wherein the accommodating element is fluidically coupled to a liquid chamber through the valve assembly.

13. The sexual stimulation device as claimed in claim 1, wherein the inside of the accommodating element is fluidically coupled to the external ambience through the valve assembly.

14. The sexual stimulation device as claimed in claim 13, wherein the external ambience at least includes a first liquid chamber containing a first type of liquid and a second liquid chamber containing s second type of liquid, the actuation member operates the valve in the first mode to allow inflow of the first type of liquid and operates the valve in the second mode to allow inflow of the second type of liquid.

15. The sexual stimulation device as claimed in claim 14, wherein external ambience includes a third liquid chamber, the actuation member operates the valve in a third mode to allow outflow of the second type of liquid to the third liquid chamber, or operates the valve in the second mode to allow outflow of the first type of liquid to the third liquid chamber.

16. The sexual stimulation device as claimed in claim 1, wherein the valve assembly includes a four-channel valve assembly or a five-channel valve assembly or a six-channel valve assembly.

17. The sexual stimulation device as claimed in claim 1, wherein the actuation member is operatively coupled to a control circuitry.

18. A sexual stimulation device used to act on a user's orifice or surroundings thereof, comprising:
a valve assembly including at least a valve, a first channel and a second channel; and
an actuation member configured to operate the valve at least in a first mode and a second mode, so as to fluidically couple an external ambience to the orifice or the surroundings thereof through the valve assembly;
wherein, the actuation member is configured to operate the valve in the first mode to allow a first fluid flow through the first channel between the orifice or the surroundings thereof and the external ambience, and operate the valve in the second mode to allow a second fluid flow through the second channel between the orifice or the surroundings thereof and the external ambience,
and wherein the first fluid flow and the second fluid flow are separately controllable.

19. The sexual stimulation device as claimed in claim 18, wherein the first fluid flow and second fluid flow produce at least one or more stimulation among lubrication, cleaning, expansion, and compression for the orifice or the surroundings thereof.

20. The sexual stimulation device as claimed in claim 18, wherein the external ambience is fluidically coupled a clitoris of the user through the valve assembly.
